(19) United States
(12) Patent Application Publication
(10) Pub. No.: US 2003/0007306 A1
(43) Pub. Date: Jan. 9, 2003

(54) Method and apparatus for protecting vehicles

(76) Inventor: Harold Edward Siess, Gaithersburg, MD (US)

Correspondence Address: Harold E. Siess, 8629 Welbeck Way, Gaithersburg, MD, 20879, US

(21) Appl. No.: 09/988,885

(22) Filed: Nov. 20, 2001

Related U.S. Application Data
(63) Continuation-in-part of application No. 09/455,164, filed on Dec. 6, 1999, now Pat. No. 6,379,427.

(51) Int. Cl. H01H 1/00

(52) U.S. Cl. 361/230; 361/225

(57) ABSTRACT

The present invention provides for a method and apparatus for protecting a vehicle from a plurality of harmful airborne agents. The method comprises the steps of generating a plurality of charged particles from a charged particle source mounted on said vehicle for imparting the vehicle with a positive charge and irradiating the harmful airborne agents with radiation from a radiation source which is also mounted on the vehicle for forming positively charged harmful airborne agents for protecting the vehicle by electrostatic repulsion.

### BACKGROUND OF THE INVENTION

Past efforts for protecting aircraft from ice accumulation using radiation sources have been limited to either heating the surface of the aircraft itself or in heating the cold droplets before they freeze. These prior method and apparatuses do not provide for a method and apparatus for repelling the droplets away from the surface of the aircraft

### SUMMARY OF THE INVENTION

As used herein the words “vision field” is defined as the region of space as seen by object if it had eyes.

The present invention also provides for a method and apparatus for protecting both animate and inanimate objects such as an aircraft from harmful airborne agents. The method comprises the steps of first, connecting a charging device to an object such as an aircraft for providing a positive charge thereto. One or more radiation source is also actuated for forming one or more beams of ultraviolet radiation for impinging upon a plurality of harmful airborne agents for ejecting an electron therefrom and thereby electrifying the harmful airborne agents with a positive charge for repelling the harmful airborne agents from the object for protecting the object from harmful airborne agents.

The present invention provides for a method and apparatus for protecting an aircraft, such as a plane, jet or helicopter, from ice accumulation during flight. The method comprising the steps of first, mounting an ultraviolet radiation source to an aircraft for providing radiation therefrom and electrically connecting a charged particle source to the aircraft for providing charged particles therefrom. During icing fight conditions, a sensor sends a signal to the charged particle source for ejecting a plurality of negative particles from the aircraft for electrostatically charging at least a portion of the aircraft with a positive charge. The sensor also actuates the radiation source for forming a beam of ultraviolet radiation. The beam is focused upon on coming water droplets for ejecting an electron therefrom and thereby electrifying the droplets with a positive charge for repelling the droplets from the aircraft for protecting the aircraft from ice accumulation.

### BRIEF DESCRIPTION OF THE DRAWINGS

FIG. 1, shows a schematic of a method and apparatus for protecting an object from harmful airborne agents by the use of a radiation charger.

FIG. 2, shows a schematic of a method and apparatus for protecting an aircraft from ice accumulation during flight.

FIG. 3, there is shown a schematic of a method and apparatus for protecting a parked aircraft from freezing droplets of water.

FIG. 4, there is shown a schematic of a method and apparatus for protecting an aircraft from ice accumulation during flight by use of a heated wire electrode.

### DETAILED DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

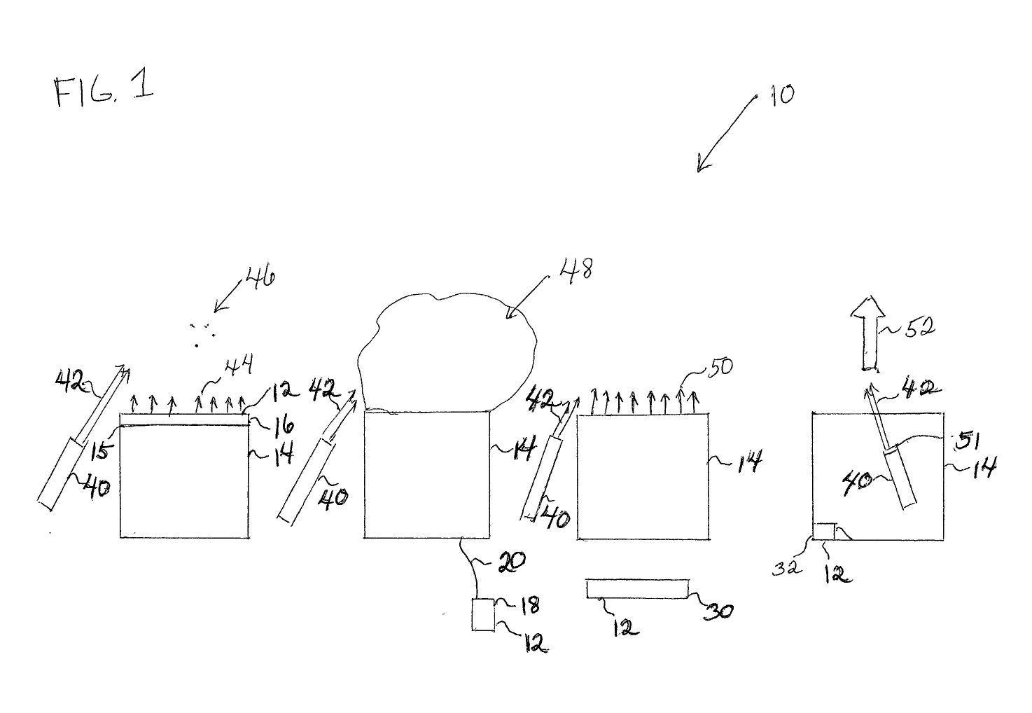

Now referring to FIG. 1, there is shown a schematic of a method and apparatus for protecting an object from harmful airborne agents by the use of a radiation charger. The apparatus is a harmful airborne agent deflector generally indicated by the numeral 10.

The harmful airborne agent deflector 10 operates as now described. First, a charging device 12 is provided for establishing a positive electrostatic charge on at least a portion of an object 14. Charging device 12 can be comprised of, for example, (1) an electret 16 that is boned to object 14 by an adhesive material 15, (2) an electrostatic generator 18 that is electrically connected to object 14 through an electrical cable 20, (3) an inducer 30 for electrostatically charging object 14 by induction, or (4) a charged particle source 32 for charging object 14 by the emission of a plurality of unipolar charged particles (not shown). Object 14 can be isolated from ground for maintaining an electrostatic charge on object 14.

After an electrostatic charge has been placed on object 14, one or more radiation sources 40 are actuated for forming one or more beams of radiation generally indicated by the arrow 42. In one form of the invention, beam(s) 42 are focused within at least a portion of a vision field generally indicated by the arrows 44 for ejecting electrons from a plurality of harmful airborne agents generally indicated by the numeral 46 located therein for electrostatically charging at least a portion of agents 46 with a positive electrostatic charge for protecting object 14 from agents 46.

Radiation source 40 may have a wavelength greater than 3 eV for ejecting electrons from harmful airborne agents 46 having an effective work function of greater than 3 eV. In one form of the invention, radiation source 40 has a wavelength greater than 6 eV for ejecting electrons from harmful airborne agents 46 comprised of water. Radiation source 40 can be, but is not limited to, an ultraviolet flashlamp or an excimer laser or a source of s-rays.

In another form of the invention, beam(s) 42 are focused within a sea of harmful airborne agents generally indicated by the numeral 48 that is in fluid communication with object 14 for electrifying agents 48 therein.

In still another form of the invention, beam(s) 42 are focused within an electrostatic field generally indicated by the arrows 50 for electrifying harmful airborne agents 46 located therein.

In still yet another form of the invention, beam(s) 42 are focused within a travel path generally indicated by the arrow 52 such as a flight path or road for electrifying harmful airborne agents 46 therein. In this form of the invention, both radiation source 40 and one or more lens 51 can be directly attached to object 14 for continuously illuminating the travel path 52. This form of the invention, is particularly useful for protecting occupants of a vehicle from harmful airborne agents in the form of a cloud of chemical or biological.

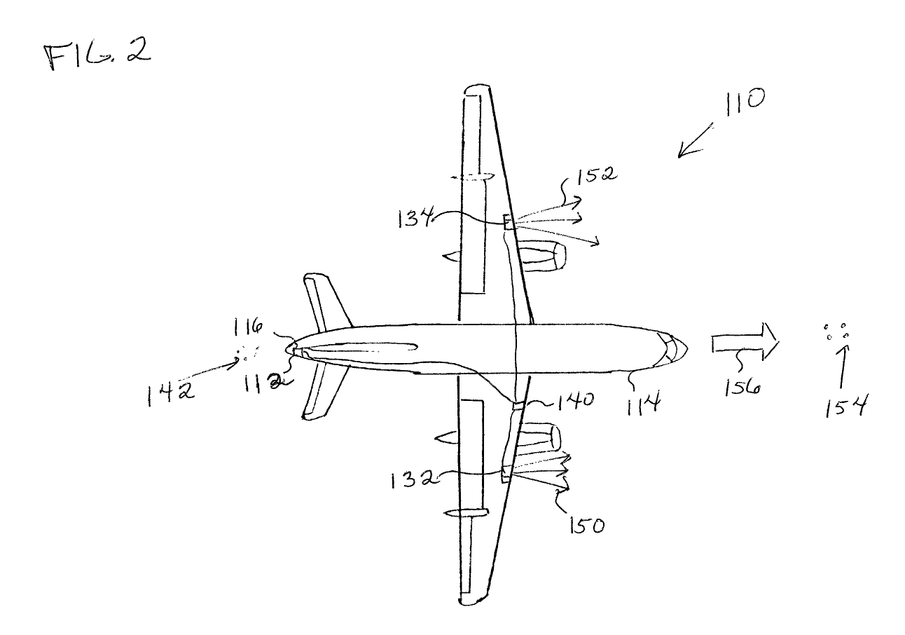

Now referring to FIG. 2 there is shown a schematic of method and apparatus for protecting an aircraft from ice accumulation during flight. The apparatus is an electrostatic droplet repeller generally indicated by the numeral 110.

The electrostatic droplet repeller 110 operates in a manner now described. A charged particle source 112 is electrically connected to an aircraft 114 through a cable 116. Charged particle source 112 can be comprised of a corona device which is electrically connected to an electrostatic generator. Aircraft 114 can be in the form of a helicopter, plane or jet.

One or more ultraviolet source(s) 132 and 134 of radiation are also mounted on aircraft 114.

During icing flight conditions, an ice sensor 140, of a type well known in the art, sends a signal to charged particle source 112 for ejecting a plurality of negatively charged particles generally indicated by the numeral 142 away from aircraft 114 for placing a positive electrostatic charge on at least a portion of aircraft 114. Negatively charged particles 142 can be in the form of electrons. In the preferred form of the invention, the magnitude of the electrostatic charge on aircraft 114 is held just below the breakdown voltage of the air.

Sensor 140 also activates radiation source(s) 132 and 134 for forming a beam generally indicated by the arrows 150 and 152 of radiation. Beams 150 and 152 are focused upon a plurality of on coming freezing water droplets generally indicated by the numeral 154 contained in a flight path generally indicated by the arrow 156 of the aircraft 114 for electrifying droplets 154 with a positive charge for repelling droplets 154 from at least a portion of aircraft 114 for protecting aircraft 114 from ice accumulation thereon. Source 132 can be activated for forming beam 150 in the form of a continuous or intermittent beam.

In one form of the invention, beam 150 is swept over flight path 156 by a light deflector 160 for exposing flight path 156 to electrifying radiation.

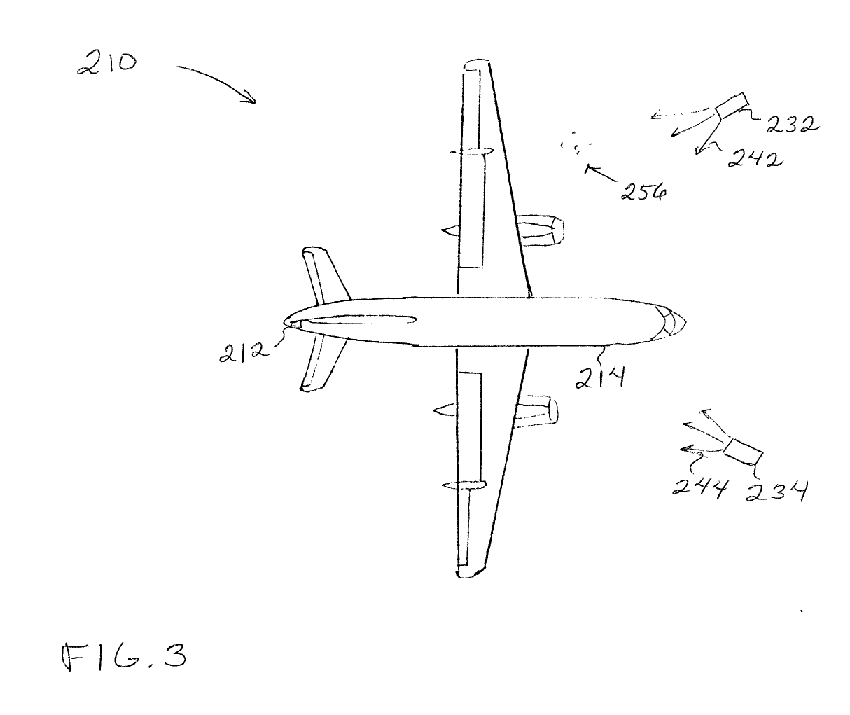

Now referring to FIG. 3, there is shown a schematic of a method and apparatus for protecting a parked aircraft from freezing droplets of water. The apparatus is a radiation umbrella generally indicated by the numeral 210.

The radiation umbrella 210 operates as now described. First, an electrostatic charge is placed on or otherwise created on at least a portion of an aircraft 214 by an electrostatic charger 212.

One or more source(s) 232 and 234 are then actuated for forming a radiation umbrella over at least a portion of aircraft 214 for electrifying a plurality of descending droplets generally indicated by the numeral 256 for protecting aircraft 214 from ice accumulation.

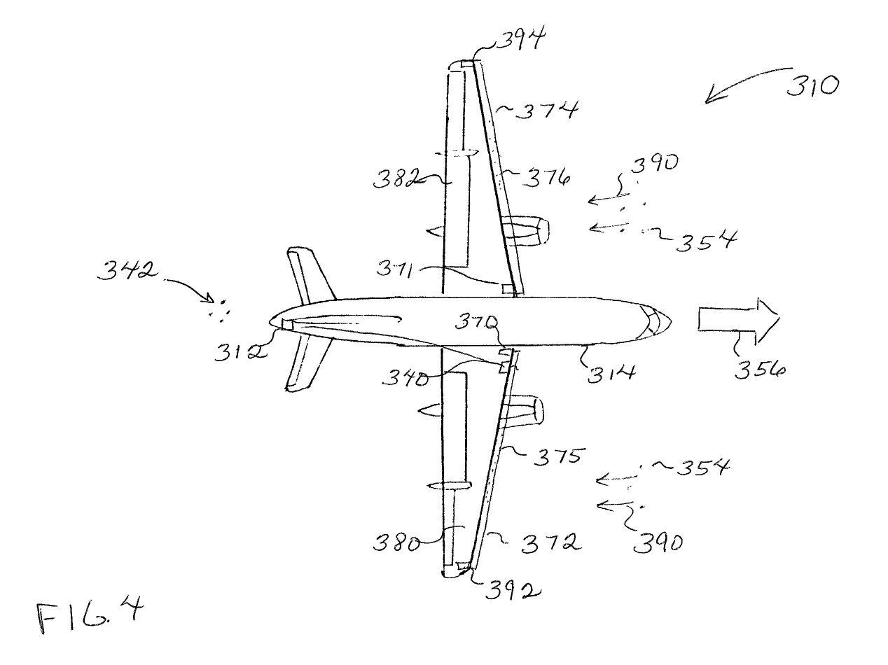

Now referring to FIG. 4, there is shown a schematic of a method and apparatus for protecting an aircraft from ice accumulation during flight by use of a heated wire electrode, The apparatus is a wired electrostatic droplet repeller generally indicated by the numeral 310.

The wired repeller 310 operates in a manner now described. First, during icing flight conditions, an ice sensor 340 sends a signal to charged particle source 312 for ejecting a plurality of charged particles 342 away from an aircraft 314 for placing an electrostatic charge on at least a portion of aircraft 314.

Sensor 340 also activates one or more electrostatic generators 370 and 371 for charging one or more wire electrodes 372 and 374 which are located in a flight path generally indicated by the arrow 356 of aircraft 314 for forming a cloud generally indicated by the numeral 375 of charged particles generally indicated by the numeral 376 having the same polarity as aircraft 314. In one form of the invention, wire electrode 372 is strung in front of a plurality of wings 380 and 382 for creating cloud 374 in the flight path of aircraft 314.

Cloud 374 of charged particles 376 electrifies a flow generally indicated by the arrow 390 containing a plurality of freezing water droplets 354 for placing a repellant charge thereon. The electrostatically charged droplets 354 are then repelled from at least a portion of aircraft 314 for the protection thereof.

One or more heaters 392 and 394 may be used to heat wires 370 and 372 by Joule heating.

1. A method for protecting a vehicle from a plurality of harmful airborne agents, said method comprising the steps of;
a) generating a plurality of charged particles for imparting said vehicle with positive electrostatic charge; and
b) irradiating said plurality of harmful airborne agents for forming positively charged harmful airborne agents for protecting said vehicle.

2. A method according to claim 1, further comprising the step of attaching an electrical cable from a charged particle source to said vehicle.

3. A method according to claim 1, further comprising generating said plurality of charged particles as a plurality of electrons from an electron emitter for positively charging said vehicle.

4. A method according to claim 3, wherein the emitter is a corona device.

5. A method according to claim 1, further comprising the step of irradiating said harmful airborne agents with a beam of radiation for ejecting a plurality of electrons therefrom by the photoelectric effect.

6. A method according to claim 1, further comprising the step of irradiating said harmful airborne agents with pulses of radiation for ejecting electrons therefrom.

7. A method according to claim 6, further comprising the step of pulsing said radiation source for irradiating said harmful airborne agents with pulses of radiation.

8. A method according to claim 6, further comprising the step of deflecting a beam of radiation for irradiating said harmful airborne agents with pulses of radiation.

9. A method according to claim 1, further comprising the step of irradiating said plurality of harmful airborne agents with uv radiation for positively charging said harmful airborne agents.

10. A method according to claim 1, further comprising the step of irradiating said plurality of harmful airborne agents with x-rays for positively charging said harmful airborne agents.

11. A method according to claim 1, further comprising the step of detecting said plurality of harmful airborne agents for sending a signal for generating charged particles and for irradiating the harmful airborne agents.

12. A method according to claim 1, further comprising the step of pointing radiation in the travel path of said vehicle for irradiating said plurality of harmful airborne agents therein.

13. An apparatus for protecting a vehicle from harmful airborne agents, comprising;
a) a charged particle source mounted on said vehicle for generating a plurality of charged particles; and
b) a radiation source mounted on said vehicle for irradiating a plurality of harmful airborne agents for forming positively charged harmful airborne agents for protecting said vehicle.

14. An apparatus according to claim 13, further comprising a charged particle source with an electrical cable attached thereto for attaching onto said vehicle.

15. An apparatus according to claim 13, further comprising an electron emitter.

16. An apparatus according to claim 15, wherein said electron emitter is a corona device.

17. An apparatus according to claim 13, wherein said radiation source has an energy output for ejecting a plurality of electrons from said harmful airborne agents by the photoelectric effect.

18. An apparatus according to claim 13, further comprising a radiation pulser or irradiating said harmful airborne agents with pulses of radiation.

19. An apparatus according to claim 18, wherein said pulser is comprised of a pulsed radiation source.

20. An apparatus according to claim 18, wherein said pulser is a beam deflector.

21. An apparatus according to claim 13, wherein said radiation source is a UV radiation device.

22. An apparatus according to claim 13, wherein said radiation source is a x-ray device.

23. An apparatus according to claim 13, further comprising a detector for detecting harmful airborne agents for sending a signal to said charged particle source and said radiation source.

24. An apparatus according to claim 13, further comprising a lens position on said vehicle for focusing a beam of radiation from said radiation source in the travel path of said vehicle.
